(19) United States
(12) Patent Application Publication
(10) Pub. No.: US 2017/0070280 A1
(43) Pub. Date: Mar. 9, 2017

(54) METHOD AND SYSTEM FOR PROVIDING DIVERSITY IN POLARIZATION OF ANTENNAS

(71) Applicant: FUNDACIO CENTRE TECHNOLOGIC DE TELECOMUNICACIONS DE CATALUNYA, Castelldefels Barcelona (ES)

(72) Inventors: Pol HENAREJOS HERNANDEZ, Castelldefels Barcelona (ES); Ana Isabel Perez Neira, Castelldefels Barcelona (ES)

(21) Appl. No.: 15/122,875

(22) PCT Filed: Jan. 30, 2014
(86) PCT No.: PCT/EP2014/051801

§ 371 Date: Aug. 31, 2016

(51) Int. Cl. H04B 7/10; H04W 72/08; H04B 7/04

(52) U.S. Cl. CPC H04B 7/10; H04B 7/0413; H04W 72/087

(57) ABSTRACT

A method and system provide diversity in polarization of antennas, called here Polarized Modulation (PM), and include a receiver with a single receiving antenna, which is double polarized for receiving a signal y to obtain b+1 bits of information from a symbol s transmitted by a double-polarized single transmitting antenna. The receiver includes an estimator block for estimating the additional bit e to determine whether a first polarization or a second polarization is used in the transmission, in order to recover the b+1 bits of information. The PM exploits Spatial Modulation (SM), but applied for Polarization instead of antennas, in mobile and fixed satellite communications, ensuring an increase of throughput while guaranteeing a minimum increase in power usage and a given required QoS.

### FIELD OF THE INVENTION

The present invention has its application within the telecommunication sector, and especially, relates to a system and method for providing spatial diversity.

### BACKGROUND OF THE INVENTION

Multiple-Input Multiple-Output (MIMO) schemes were introduced as a promising way to increase notably the spectral efficiency using multiples antennas at transmission and/or reception.

Among the different existing approaches (spatial diversity, beamforming or spatial multiplexing), Vertical Bell Laboratories Layered Space-Time (V-BLAST) scheme and successive improvements presented a simple way to double the rate with a relative increase of the complexity. However, V-BLAST introduced more interference between the streams because all the signals are transmitted through all antennas without any interference pre-cancellation. Thus, the signals shall be transmitted with a higher amplitude to guarantee the same values of Quality of Service (QoS).

In contrast to V-BLAST, Spatial modulation (SM) appeared recently to increase the spectral efficiency, but maintaining the same power levels of single antenna transmissions. In SM, the bits of information are split in some blocks of information which are coded as antenna indices. The rest of bits are transmitted through those antennas that are selected previously by those split bits. Hence, the receiver can estimate the antenna indices and therefore decode those indices to bits. It is known that the basic operational principle of Spatial Modulation offers a single Radio Frequency (RF) chain implementation which results into increased Energy Efficiency. However, this SM approach, is very sensitive to the channel variations and requires accurate channel estimation.

In satellite communications, the long distance prevents this approach to be applied because the channel may be correlated and the elevation angle for each antenna is practically the same from the Earth. Hence, the sensitivity of the terminal is not enough to distinguish the spatial path and detect the antenna index. Because of this, spatial modulation seems not suitable as it does not provide sufficient diversity. In fact, one of the major drawbacks in mobile satellite communications is that the power budget is often restrictive, making unaffordable to improve the spectral efficiency without more power expenses.

On the other hand, dual polarized antennas traditionally used for broadcasting, where subscribers only tuned a single polarization, have also been applied in MIMO scenarios since the recent studies unveil that dual-polarized MIMO is richer in terms of diversity (“Statistical Modeling of Dual-Polarized MIMO Land Mobile Satellite Channels”, by A. I. Perez-Neira et al., IEEE Transactions on Communications, Vol. 58, NO. 11, pages 3077-3083, 2010).

Additionally, the use of dual polarized antennas is increasing by the fact that new possibilities are arising and the newest standards include dual polarized MIMO, such as Digital Video Broadcasting Next Generation Handheld (DVB-NGH).

Regarding the use of dual polarized antennas, but in other satellite communication scenarios where there is no the severe throughput restrictions required by video streaming and other transmissions, U.S. Pat. No. 5,822,429 discloses a system for preventing reception and recognition of global positioning satellite (GPS) signals from unauthorized receivers. This GPS (selective denial) system comprises a jamming unit for propagating jamming waveforms and at least one receiver unit for receiving GPS signals as well as the propagated jamming waveforms. The jamming unit comprises a transmit antenna unit for propagating a jamming waveform at two distinct polarization states, and a transmit control switching unit for controlling the sequence of the two propagated polarization states in accordance with an encryption scheme. The receiver unit(s) include(s) a receive antenna unit and a jamming waveform suppression unit for suppressing each polarized state of the received jamming waveforms. The jamming signals, in their simplest form, employ a bi-polarization keying (BPK) defined as synchronously switching and radiating between two (or more) polarization states at a near 100-percent denial duty-cycle. An encoded switching modulation waveform controls switching between the polarization states by using a pseudo-noise encryption technique which allows asynchronous reception, decoding and synchronization for authorized users inputting to the GPS receiver.

Finally, many project conclusions report that the throughput can be increased as in a conventional MIMO system but without expenses of adding more antennas, and the consequent RF chains (“Dual polarization for {MIMO} processing in multibeam satellite systems” by A. I. Perez-Neira et al., 10th International Workshop on Signal Processing for Space Communications, 2008). One of the major benefits is the low cross channel interference due to mutual couplings between radiofrequency (RF) components. However, even though the channels are quasi perfectly independent, there is still a field to investigate in order to mitigate the interferences.

The first attempt is to extend the V-BLAST scheme to dual polarized schemes. Nevertheless, as recent projects unveil, this attempt requires higher power contributions to maintain the same QoS on point-to-point clients.

Another existing solution worthy of mention is “SINGLE ANTENNA SPACIAL DIVERSITY” by Shuang Zhao et al., 5^{th} International Conference on Wireless Communications, Networking and Mobile Computing, 2009. This approach uses Spatial Diversity in a single antenna but the antenna is moved in the space around a geographical area. Therefore, the Spatial Diversity achieved in this system depends upon the speed with which the antenna is moved. Hence, the solution only applies to static or quasi-static rich scattering environments but cannot be translated to mobile scenarios due to several reasons. A first reason is that an antenna requiring to be moved by a motorized device with displacement guide means cannot be integrated in a mobile device of satellite communications. Another reason is that the approach by Shuang Zhao et al. is only a transmission unit but has nothing to do with a complete communication system that includes at least a receiving unit.

Therefore, there is a need in the state of the art for a system and method that ensures an increase of the overall performance in terms of throughput in satellite transmissions, the more challenging mobile case included, while guaranteeing a required minimum of QoS (Quality of Service) and needing a minimum increase in power usage.

### SUMMARY OF THE INVENTION

The present invention solves the aforementioned problems by disclosing a method and system that applies Spatial Modulation (SM) to dual polarized communications in (mobile and fixed) satellite channels. The proposed solution is here entitled Polarized Modulation (PM) and exploits the SM concept but applied for the polarization instead of antennas, providing spatial diversity using a single one double-polarized antenna (i.e., in the context of this invention, spatial diversity is not the same as antenna diversity but equal to diversity in polarization).

The present invention achieves a relevant increase of throughput in satellite communications using low complex solutions which can involve hard and soft detections of the received signal. The present invention only requires 0.4 dB of additional power in order to guarantee the same QoS if compared with the case where single polarization is used. Also, the present invention can be applied and validated for the ETSI's satellite related standards.

According to a first aspect of the present invention, a method for providing diversity in polarization of antennas is disclosed and comprises the following steps:
transmitting a symbol s, which contains b bits and an additional bit c, using a first polarization or a second polarization of a single one transmitting antenna which is double polarized, whose polarization is determined by the additional bit c;
receiving a signal y by a single one receiving antenna which is also double polarized and, at the receiving end, estimating the additional bit c to determine whether the first polarization or the second polarization is used to obtain the b+1 bits of information with which the symbol s is recovered.

Another aspect of the present invention relates to a receiver for providing diversity in polarization of antennas, comprising:
a single one receiving antenna which is double polarized for receiving a signal y to obtain b bits of information and an additional bit c from a transmitted symbol s,
an estimator block for estimating the additional bit c to determine whether the first polarization or the second polarization is used to obtain the b+1 bits of information.

Another aspect of the present invention relates to transmitter for providing diversity in polarization of antennas, comprising a single one transmitting antenna which is double polarized for transmitting a symbol s containing b+1 bits of information to be recovered by the above defined receiver.

Another aspect of the present invention is referred to a system, which is integrated in a telecommunications network, e.g., a satellite communications network, for providing diversity in polarization of antennas. The system comprises a transmitter and receiver, as described before:
the transmitter comprises a single one transmitting antenna which is double polarized for transmitting the symbol s, the symbol s containing the b bits plus an additional bit c and being transmitted using a first polarization or a second polarization of the transmitting antenna depending on the additional bit c;
the receiver comprises a single one receiving antenna which is double polarized for receiving the signal y and further comprises the estimator block for estimating the additional bit c to determine whether the first polarization or the second polarization is used to obtain the b+1 bits of information.

In a last aspect of the present invention, a computer program is disclosed which comprises computer program code means adapted to perform the steps of the described method when said program is run on a computer, a digital signal processor (DSP), a field-programmable gate array (FPGA), an application-specific integrated circuit (ASIC), a micro-processor, a micro-controller, or any other form of programmable hardware.

The method and system in accordance with the above described aspects of the invention have a number of advantages with respect to prior art, summarized as follows:
The present invention achieves an improvement in throughput of up to 100% with an increase of less than 1 dB at low EbN0 regime using a double polarized antenna in the transmitter and in the receiver. Although some existing prior-art systems, such as the VBLAST or Alamouti's codes, also use polarized antennas, they always provide marginal gains and often need an increase of the power budget.
The present invention is computationally low complex and does not imply any hardware modifications with respect to the existing dual polarized systems. Hence, it can be used in current deployments where dual polarized transmissions are used. Thanks to the signal processing formulation of the proposed PM solution, it is possible to enhance the throughput with a small increment of the EbN0. As an example, using the VBLAST case, although an increment of 100% can be fulfilled, an increment of more than 3 dB is needed of power radiation.
Regarding U.S. Pat. No. 5,822,429, none of the application scenarios and the modulation used are the same as the ones applied in the present invention. The system described in U.S. Pat. No. 5,822,429 uses BPK modulation, while the present invention applies the proposed polarized modulation (PM) which can be compared with traditional modulations (BPSK or QPSK) of mobile satellite communications scenarios. U.S. Pat. No. 5,822,429 relates to GPS jamming scenarios and the goal is to inhibit received jamming signals. On the contrary, the purpose of the present invention is to increase the throughput in satellite communications. Both the present invention and the system disclosed in U.S. Pat. No. 5,822,429 refer to switching between polarization states, but U.S. Pat. No. 5,822,429 teaches a random switching between polarization states, unlike the proposed PM of the present invention which switches between the two polarization states in a deterministic way as described before.
Regarding the teachings by Shuang Zhao et al, in “SINGLE ANTENNA SPACIAL DIVERSITY”, this approach is just only for (quasi-)static scattering scenarios and the antenna needs to be moved around a geographical area. By contrast, the present invention uses a single antenna at a fixed location point and deals not only with fixed communications but also with mobile scenarios where the transmission conditions suffer from fast changes.

These and other advantages will be apparent in the light of the detailed description of the invention.

### DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 shows a block diagram of a transmitter system for providing diversity in polarization of antennas according to a preferred embodiment of the invention.

FIG. 2 shows a block diagram of a receiver side in a system for providing diversity in polarization of antennas according to a preferred embodiment of the invention.

FIG. 3 shows a graphical representation of throughput versus energy per bit to noise power spectral density ratio, according to possible embodiments of the invention and compared with prior art approaches.

FIG. 4 shows a graphical representation of bit error rate versus energy per bit to noise power spectral density ratio, according to possible embodiments of the invention and compared with prior art approaches.

### PREFERRED EMBODIMENT OF THE INVENTION

The matters defined in this detailed description are provided to assist in a comprehensive understanding of the invention. Accordingly, those of ordinary skill in the art will recognize that variation changes and modifications of the embodiments described herein can be made without departing from the scope and spirit of the invention. Also, description of well-known functions and elements are omitted for clarity and conciseness.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

In the context of the invention, the following concepts are used:
Bit error rate (BER) is the number of bit errors divided by the total number of transferred bits during a studied time interval
Eb/N0 is the energy per bit to noise power spectral density ratio
BLock Error Rate (BLER)=Number of erroneous blocks/Total number of Received Blocks
Throughput (T) is defined as T=R(1−BLER)
   which is equivalent to the symbol rate (R) of a particular radio bearer weighted by the probability of non-error in the whole block.

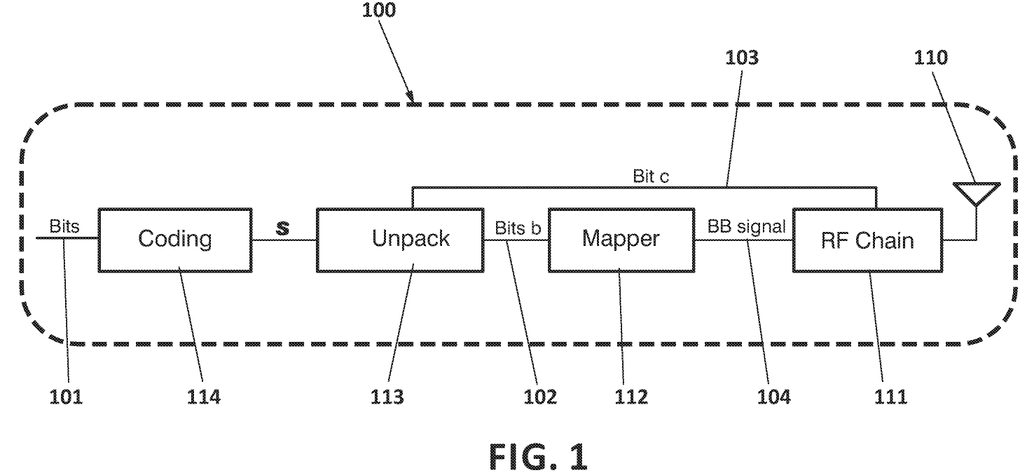

It is within this context, that various embodiments of the invention are now presented with reference to the FIGS. 1-4.

FIG. 1 presents the architecture building blocks of a transmitter (100) performing the proposed Polarized Modulation. The transmitter (100) is part of a system for providing diversity in polarization of antennas, in which each symbol to be transmitted contains b+1 bits of information (101), where b bits (102) are modulated with a constellation [symbol] , and the remaining additional bit (103), denoted as bit c, is used for polarization selection. Any kind of digital modulation as in traditional schemes can be applied to the b bits (102).The modulated symbol to be transmitted is denoted as s in the equations below. Depending on the value of bit c, the symbol s is transmitted using one polarization or the other. The transmitter (100) has a single transmitting antenna (110) which is double polarized and attached to a single RF chain (111), through which the—BB—baseband signal (104) is injected in the two polarized waveforms. The Mapper (112) block performs all stages to produce the waveform, e.g., using QPSK symbols. The Unpack block (113) makes groups of b+1 bits and extracts from each group just one bit, e.g., the first bit, which is the bit c used by the RF chain (111) to control the polarization of the transmitting antenna (110). The bits of information (101) are input to a coding block (114) of the transmitter (100) and the coding block (114) generates the modulated symbols s using the constellation [symbol] , e.g., BPSK, QPSK, etc. In fact,

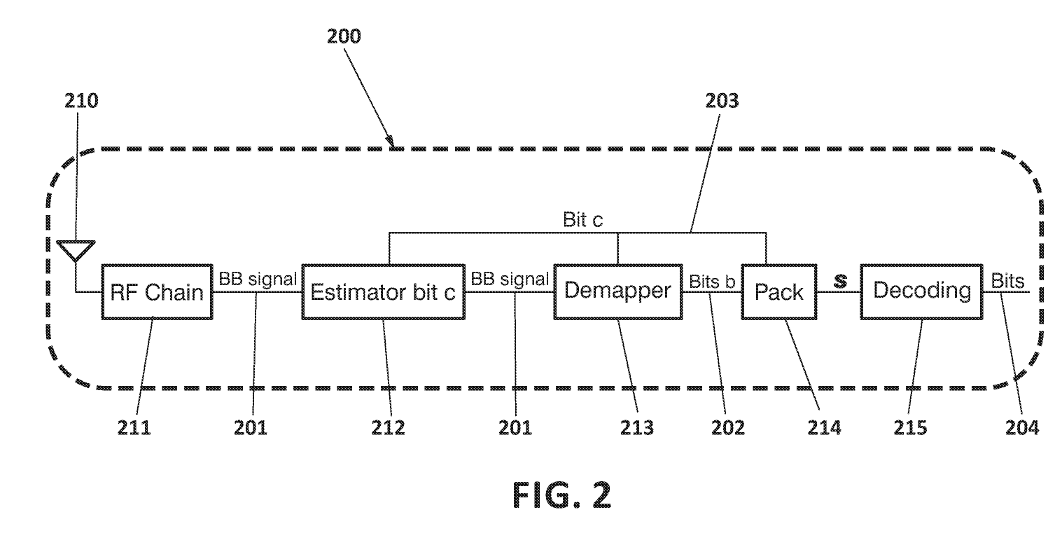

FIG. 2 presents the architecture building blocks of a receiver (200) forming part of the system for providing diversity in polarization of antennas, in accordance with an embodiment of the invention. The receiver (200) has a single receiving antenna (210) with dual polarization. Thus, a system with double polarized antennas at both sides is considered. Also, a flat communication channel between the transmitter (100) and receiver (200) of the system is assumed. A baseband signal (201) is extracted at the receiving side from a single RF chain (211) attached to the receiving antenna (210). The baseband signal (201) passes through an estimator block (212) which extracts the bit c according to a demodulation schema. Three demodulation schemes are described below, based on channel matching, on likelihood ratio with hard decision and on likelihood ratio with soft decision respectively. The receiver (200) further comprises a demapper (213) block which recovers the bits b taking as an input the bit c estimated by the estimator block (212) using one of the three proposed schemes. The receiver (200) includes a packing block (214) for taking all the b+1 bits, bits b from the demapper (213) and the estimated bit c, in order to join them all to a single stream s which is finally decoded by a decoding block or decoder (215) to obtain the bits of information (204). The decoder (215) uses a modulation scheme in correspondence with the one used by the coding block (114) included in the transmitter (100, e.g., BPSK, QPSK, 8PSK, 16QAM, 64QAM, 256QAM . . . .

The proposed system is based on dual polarized antennas providing spatial diversity at transmission using a single antenna and can increase the throughput by a factor of 1+1/b in low EbN0 regimes.

In a preferred embodiment of the proposed system for satellite communications, the data payload at the transmitter (100) can be constructed on ground as two streams (one for each polarization) in such way that the zeroed symbols are interleaved, i.e. when the first stream contains a symbol, the second contains a zero and vice versa. Thus, the satellite can increase the throughput but maintaining the legacy and compatibility with previous standards.

Regarding the reception side, the receiver (200) can use a single RF chain (211) and the only requirement is the capability to switch among the polarizations faster than the symbol rate R. Hence, using that solutions and the different proposed approaches for coding describe below, the terminal may receive the additional bit c preserving the same chain.

As explained before, depending upon the value of bit c, the symbol s is transmitted using one polarization or the other applied to the transmitting antenna (110). Hence, for a time instant, the system model of Polarized Modulation (PM) can be formulated as follows:

$$( \begin{matrix}{y}_{1} \\ {y}_{2}\end{matrix} ) = ( \begin{matrix}{h}_{11} & {h}_{12} \\ {h}_{21} & {h}_{22}\end{matrix} ) ( \begin{matrix}1 - c \\ c\end{matrix} ) s + ( \begin{matrix}{w}_{1} \\ {w}_{2}\end{matrix} ) \qquad ( equation 1 )$$

The co-channels across the two polarizations of the transmitting antenna (110) are denoted as h₁₁ and h₂₂ respectively, and the cross-channels across both polarizations are denoted as h₂₁ and h₁₂ respectively. The received signals of each polarization in the receiving antenna (210) are denoted as y₁ and y₂, respectively, and wᵢ is the Additive White Gaussian Noise (AWGN) contribution of the ith polarization, i=1,2.

In a more compact way, equation 1 can be written as:

y=Hcs+w. (equation 2)

Since this scheme adds an additional bit c to the transmission while keeping the same power budget, the spectral efficiency G of the system is:

$$G = \frac{b + 1}{b} = 1 + \frac{1}{b} . \qquad ( equation 3 )$$

For higher order modulations, the value of equation 3 is asymptotically equal to 1 and thus, the proposed PM system offers high gains mainly for lower order modulations. For instance, the gain G=2 for BPSK or G=1.5 for QPSK modulations. As the lower order modulations are used in low signal to noise (SNR) regime, it is clear that PM increases significantly the spectral efficiency in low SNR systems. This is exactly the scenario for mobile satellite communications which is extremely power limited. It is worth to mention that in this proposed model, firstly, the additional bit c is determined by the estimator block (212) so that, once bit c is estimated, the receiver (200) can take the received signal of the estimated polarization index and process it as a Single-input Single-output (SISO) case.

In order to decode the information at the receiver (200), three different approaches are proposed here, which achieve different results at expenses of complexity increase.

### First Approach: Channel Matching

The first approach is to apply a matched filter to the baseband signal (201) translated from the received signal in the receiving antenna (210). The channel coefficients are assumed to be uncorrelated, i.e., hᵢ*hⱼ=0, ∀i≢j. Hence, the matched signal r is obtained as follows:

$$r = {H}^{H} y = ( \begin{matrix}{\vert {h}_{11} \vert}^{2} + {\vert {h}_{21} \vert}^{2} & 0 \\ 0 & {\vert {h}_{22} \vert}^{2} + {\vert {h}_{12} \vert}^{2}\end{matrix} ) cs + w . \qquad ( equation 4 )$$

Focussing on the individual matched signals, r₁ and r₂, at each polarization, they can be obtained following the criteria of equation 5 below:

r₁=(|h₁₁|²+|h₂₁|²)(1−c)s+w₁r₂=(|h₂₂|²+|h₁₂|²)cs+w₂ (equation 5)

In the case where the signal is being transmitted through the first polarization, i.e., c=0, the first matched signal r₁ contains the signal plus noise and the second matched signal r₂ only receives the noise. For the reciprocal case, through the second polarization, i.e., c=1, the first matched signal r₁ contains only the noise and the second matched signal r₂ conveys the signal plus the noise. The noise is not only the thermal noise but also considers the cross-polar interferences. Therefore, the decision rule to determine bit c by the estimator block (212) is denoted as:

ĉ=arg maxᵢ(|rᵢ|²)−1 (equation 6)

Thus, after the decision of estimated bit ĉ, the receiver (200) is able to decode the symbol s by the decoding block (215) based on the matched signal r_{ĉ}+1.

However, this first approach based on channel matching is very sensitive to the accuracy of the estimation of the matched signal r_{ĉ+1}. If an error occurs, the detection of symbol s fails and the remaining b bits cannot be decoded since the receiver (200) takes the matched signal r_{ĉ+1} as it only would contain noise.

### Second Approach: Likelihood Ratio with Hard Decision

As mentioned before, the matched filter approach is very sensitive to channel and cross-polar coupling impairments. Furthermore, the assumption about channel's coefficients uncorrelation is not always plausible. In practice, this assumption is quite strong and may not be fulfilled. Because of that, another second embodiment of the invention to obtain the likelihood ratio of transmitting with the first polarization (c=0) or with the second polarization (c=1) is proposed when the uncorrelation assumption is not further required. That is equivalent to propose a likelihood ratio Λ(y) of transmitting with any of the two possible polarizations at the transmitting antenna (110):

$$Λ ( y ) = \frac{P ( c = 1 \vert y )}{P ( c = 0 \vert y )} = \frac{{\sum }_{\tilde{s} ∈ S} P ( y \vert c = 1 , s = \tilde{s} ) P ( c = 1 )}{{\sum }_{\tilde{s} ∈ S} P ( y \vert c = 0 , s = \tilde{s} ) P ( c = 0 )} . \qquad ( equation 7 )$$

Assuming all bits are uncorrelated and equally probable, equation 7 can be rewritten as follows:

$$Λ ( y ) = \frac{{\sum }_{\tilde{s} ∈ S} exp ( - \frac{{‖ {z}_{2} ‖}^{2}}{{σ}_{{w}_{2}}^{2}} )}{{\sum }_{\tilde{s} ∈ S} exp ( - \frac{{‖ {z}_{1} ‖}^{2}}{{σ}_{{w}_{1}}^{2}} )} \qquad ( equation 8 )$$

where zᵢ i∈{1,2} are defined as the received signal vectors in the case that the symbols s are transmitted through the first polarization (i=1) or the second polarization (i=2) respectively. Hence, the received signal vectors z_{i∈{1,2}} take this form:

$${z}_{1} = ( \begin{matrix}{h}_{11} s + {w}_{1} \\ {h}_{21} s + {w}_{2}\end{matrix} ) \\ {z}_{2} = ( \begin{matrix}{h}_{12} s + {w}_{1} \\ {h}_{22} s + {w}_{2}\end{matrix} ) . \qquad ( equation 9 )$$

This form is equivalent to write the equation 1 defining the system model as follows:

y=h_{c+1}s+w (equation 10)

where hᵢ is the ith column of channel matrix H.

This second approach reveals that the polarization modulation switches between the polarization's channels in an opportunistic way, Thus, the likelihood ratio Λ(y) is calculated as:

$$Λ ( y ) = \frac{{\sum }_{\tilde{s} ∈ S} exp ( - \frac{{‖ y - {h}_{2} \tilde{s} ‖}^{2}}{{σ}_{{w}_{2}}^{2}} )}{{\sum }_{\tilde{s} ∈ S} exp ( - \frac{{‖ y - {h}_{1} \tilde{s} ‖}^{2}}{{σ}_{{w}_{1}}^{2}} )} . \qquad ( equation 11 )$$

being a first channel vector h₁₁,h₂₁)
being a second channel vector h₂=(h₁₂, h₂₂)
σ_{w1} is noise variance of the noise contribution of the first polarization w₁
σ_{w2} is noise variance of the noise contribution of the second polarization w₂
\tilde{S} is a summation index of the symbols s contained in the constellation

[symbol]

In the case that likelihood ratio Λ(y) is greater than 1, it means that is more probably that the additional bit c=1 and vice versa. Hence, the estimation of bit c performed by the estimator block (212) can be stated as:

$$\hat{c} = \frac{1 + sign ( log ( Λ ( y ) ) )}{2} . \qquad ( equation 12 )$$

Once the receiver (200) obtains the estimation of bit c from the estimator block (212), it knows which polarization is being used and thus it can recover the symbol s using the received signal y_{ĉ+1}.

### Third Approach: Likelihood Ratio with Soft Decision

The two approaches described above perform hard decision for the estimation of bit c. However, they can introduce errors if the system conveys coded information. Hence, it is imperative to obtain soft information or soft bits at the output of the demapper (213). The idea is to use the likelihood ratio Λ(y) to weight the signals received in both polarizations. Therefore, the receiver (200) is able to extract information from both polarizations weighting them by each probability. Equation 7 can be rewritten:

$${P}_{2} = P ( c = 1 \vert y ) = \frac{Λ ( y )}{1 + Λ ( y )} . \qquad ( equation 13 )$$

Therefore, the receiver (200) can recover the signal by weighting the received signals from both polarizations by a probability 1−P₂ and P₂, respectively. If we assume that the bit c is transmitted with equal probability, the combined received signal r takes the following form:

$$r = ( 1 - {P}_{2} ) {y}_{1} + {P}_{2} {y}_{2} = \frac{{y}_{1} + {y}_{2} Λ ( y )}{1 + Λ ( y )} \qquad ( equation 14 )$$

At this point, the receiver (200) is able to decode the signal r from equation 14 as usually and obtain the remaining b bits. Furthermore, the estimation of bit c performed by the estimator block (212) can be taken from equation 12 but without the sign ( )operator, as follows:

$$\hat{c} = \frac{1 + log ( Λ ( y ) )}{2} . \qquad ( equation 15 )$$

As follows, the proposed three schemes are analysed and compared among them and with systems existing in prior art.

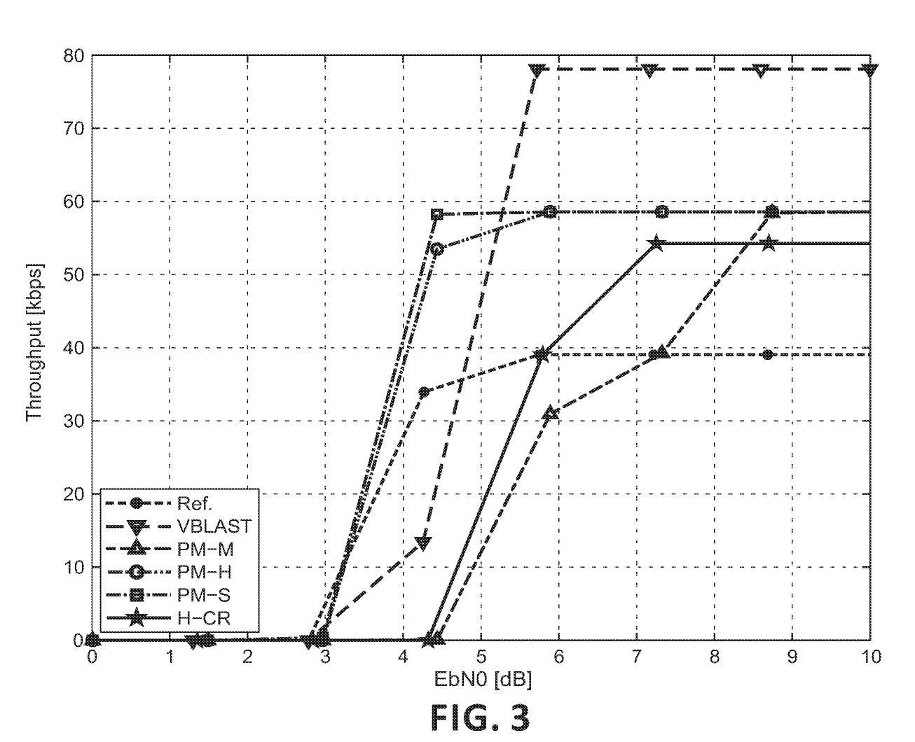

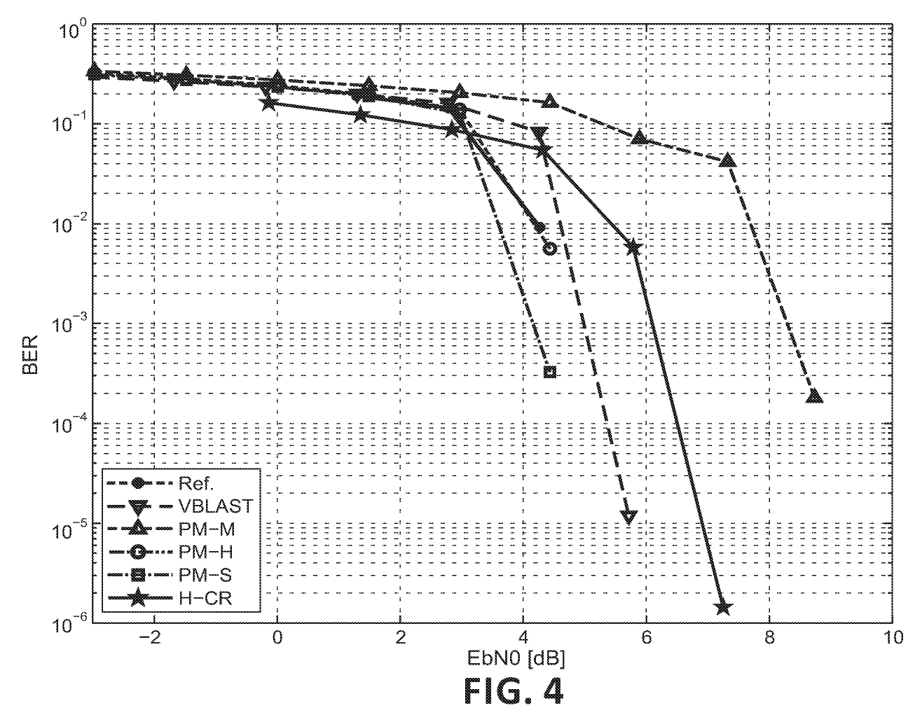

FIGS. 3 and 4 show the results of the analysis. In both FIGS. 3-4, the three presented approaches are considered: PM-M is the first approach based on channel matching; PM-H is the second approach based on likelihood ratio with hard decision and PM-S is the third approach described based on likelihood ratio with soft decision. They are also compared with an scenario H-CR which uses a higher coding rate, a reference scenario denoted as Ref. which refers to the scenario where single polarization is used; and a last scenario using Vertical Bell Laboratories Layered Space-Time (VBLAST) coding scheme aforementioned as prior art.

For the analysis, the downlink of the Next Generation Satellite Communications standard, currently being discussed at ETSI committee, was deployed. This standard defines the scrambling, turbo coding and mapping stages. In order to offer flexibility in terms of data rate, several bearers and sub-bearers are also detailed. They are different profiles with many combinations of coding rate and constellations. The sampling frequency is 33600 symbols/second and the frame length is 80 ms, where the blocks of coded symbols are not interleaved. Thanks to that, it is possible to reduce the delay and offer voice traffic data in both directions. In order to simplify the model, QPSK bearers are used for the analysis of the proposed PM approaches. An L-band geostationary satellite transponder with many beams and dual polarization has been simulated. Since the beams are not perfectly orthogonal, the adjacent beams have been assumed to be at the same frequency sub-band as interferences, as well as the cross polarization couplings. The results have been compared among the different parameters of adjacent beams.

Therefore, the following results have been validated using a framework developed for interactive mobile satellites, as the scenario specified by the newest version of ETSI TS 102 744 standard “Satellite component of UMTS (S-UMTS) and the Broadband Global Area Network system (BGAN) which aims to provide interactive mobile satellite communications.

Table 1 shows the values of the data coupling polarization matrix and the interference matrices which have been used for the analysis.

TABLE 1

| | Index | Interference matrix (dB) |
|---|---|---|
| Data | 0 | $( \begin{matrix}40.8 & - 11.6 \\ - 11.6 & 40.8\end{matrix} )$ |
| rf er | 1 | $( \begin{matrix}3.7 & - 12.3 \\ - 12.3 & 3.7\end{matrix} )$ |
| | 2 | $( \begin{matrix}8.7 & - 13 \\ - 13 & 8.7\end{matrix} )$ |
| | 3 | $( \begin{matrix}3.6 & - 6.7 \\ - 6.7 & 3.6\end{matrix} )$ |
| | 4 | $( \begin{matrix}13.4 & - .89 \\ - 8.9 & 13.4\end{matrix} )$ |
| | 5 | $( \begin{matrix}8.9 & - 4.7 \\ - 4.7 & 8.9\end{matrix} )$ |
| | 6 | $( \begin{matrix}11.6 & - 3.7 \\ - 3.7 & 11.6\end{matrix} )$ |

These values are obtained via realistic multibeam antenna pattern. A Rician channel model with a single tap, a Doppler shift of 2 Hz and correlation between polarization streams in transmission has been used. The path loss L corresponding to the height of satellite defines a magnitude of L=187.05 dB and the signal bandwidth B defined in the standard is B=200 KHz. The merit figure gain to noise temperature (G/T) is G/T=−12.5 dBi and the power used is such that the carrier to noise (C/N) varies from 1 dB to 20 dB.

Also perfect channel estimation and perfect synchronization at the receiver side is assumed. Prior to detection of symbol s, one of the three approaches (PM-M, PM-H, PM-S) are performed in order to estimate the bit c and equalize the received signal y_{ĉ+1}. The receiver implements a Minimum Mean Square Error—MMSE—equalizer to mitigate the interferences from the other beams as well as the other polarization. After the received signal y_{ĉ+1} is equalized, it is passed to the turbo decoder and scrambler to obtain the payload in bit units.

During the evaluation, using QPSK, the results showed that only an increment of ˜0.4 dB was needed to achieve a gain of 50% of spectral efficiency. Three proposed schemes PM-M, PM-H and PM-S are compared also with polarization multiplexing, noted as V-BLAST, and increasing the code rate H-CR. Both prior art schemes, V-BLAST and H-CR, increase the throughput a rate by 2 and 1.4 respectively.

FIG. 3 shows that the PM approach presented here is the one that consumes less power in order to increase the throughput by 50%, since further gains cannot be achieved because the modulation used was QPSK. More particularly, regarding the three embodiment described before: PM-S is the technique that achieves highest throughput with less EbN0, followed by PM-H. With less than 0.4 dB extra, the proposed PM technique can increase the efficiency by 50% if compared with the reference scenario (Ref.) of single polarization. Additionally, if comparing PM with VBLAST, indeed the throughput can be doubled but it requires almost 2 dB of additional EbN0. Moreover, if the reference scenario is used but with a higher coding rate, H-CR scenario, additional 3 dB of EbN0 were needed to achieve almost the same rate.

FIG. 4 compares the bit error rate (BER) for the same techniques as with the previous FIG. 3. For a fixed BER, the technique that results in less EbN0 ratio is PM-S, followed by PM-H and the Ref. scenario. It is worth to mention that the poor performance of PM-M is due to the used channel model introduces correlation among the coefficients. Hence, the matched matrix degenerates in to non-diagonal matrix and the assumption is not fulfilled.

Note that in this text, the term “comprises” and its derivations (such as “comprising”, etc.) should not be understood in an excluding sense, that is, these terms should not be interpreted as excluding the possibility that what is described and defined may include further elements, steps, etc.

1. A method for providing diversity in polarization of antennas, comprising:
transmitting a symbol s which contains b+1 bits of information by a transmitter,
receiving a signal y by a receiver which obtains the b+1 bits of information from the received signal y,
transmitting the symbol s uses a single transmitting antenna which is double polarized and the symbol s, containing the b bits plus an additional bit c, is transmitted using a first polarization or a second polarization of the transmitting antenna depending on the additional bit c; and
receiving the signal y uses a single receiving antenna which is double polarized and further comprises estimating the additional bit c to determine whether the first polarization or the second polarization is used to obtain the b+1 bits of information.

2. The method according to claim 1, wherein receiving the signal y comprises receiving by the single receiving antenna a signal of the first polarization y₁ and a signal of the second polarization y₂, being
$$( \begin{matrix}{y}_{1} \\ {y}_{2}\end{matrix} ) = ( \begin{matrix}{h}_{11} & {h}_{12} \\ {h}_{21} & {h}_{22}\end{matrix} ) ( \begin{matrix}1 - c \\ c\end{matrix} ) s + ( \begin{matrix}{w}_{1} \\ {w}_{2}\end{matrix} )$$
where
h₁₁ is a co-channel signal across the first polarization of the transmitting antenna,
h₂₂ is a co-channel signal across the second polarization of the transmitting antenna,
h₂₁ is a cross-channel signal across the first polarization of the transmitting antenna,
h₁₂ is a cross-channel signal across the second polarization of the transmitting antenna,
w₁ is a noise contribution of the first polarization and w₂ is a noise contribution of the second polarization,
and the received signal y is composed of the signal of the first polarization y₁ and the signal of the second polarization y₂.

3. The method according to claim 2, wherein the b+1 bits of information are obtained by the receiver from a signal r_{ĉ+1} selected from the signal of the first polarization y₁ and the signal of the second polarization y₂ which is determined by an estimated bit ĉ, the estimated bit c obtained by estimating the additional bit c as follows:
ĉ=arg maxᵢ(|rᵢ|²)−1.
where i=1, 2;
r₁ is a first matched signal from a matched filter of the receiver,
r₂ is a second matched
signal from the matched filter of the receiver,
and if the first matched signal r₁ is only noise, the selected signal r_{ĉ+1} is the second matched signal r₂;
and if the second matched signal r₂ is only noise, the selected signal r_{ĉ+1} is the first matched signal r₁.

4. The method according to claim 2, wherein the b+1 bits of information are obtained by the receiver using a signal y_{ĉ+1} selected from the signal of the first polarization y₁ and the signal of the second polarization y₂ which is determined by an estimated bit ĉ, the estimated bit c obtained by estimating the additional bit c as follows:
$$\hat{c} = \frac{1 + sign ( log ( Λ ( y ) ) )}{2} .$$
where Λ(y) is a likelihood ratio of transmitting with any of the first polarization and the second polarization of the transmitting antenna,
and the selected signal y_{ĉ+1} is the signal of the second polarization y₂, if the likelihood ratio Λ(y) is Λ(y)>1; and otherwise, the selected signal y_{ĉ+1} is the signal of the first polarization y₁.

5. The method according to claim 2, wherein the b+1 bits of information are obtained by the receiver from a combined received signal y_{ĉ+1} using the signal of the first polarization y₁ and the signal of the second polarization y₂ which is determined by an estimated bit ĉ, the estimated bit ĉ obtained by estimating the additional bit c as follows:
$$\hat{c} = \frac{1 + log ( Λ ( y ) )}{2} .$$
where Λ(y) is a likelihood ratio of transmitting with any of the first polarization and the second polarization of the transmitting antenna,
and the combined received signal y_{ĉ+1} is calculated as:
$${y}_{\hat{c} + 1} r = ( 1 - {P}_{2} ) {y}_{1} + {P}_{2} {y}_{2} = \frac{{y}_{1} + {y}_{2} Λ ( y )}{1 + Λ ( y )}$$

6. The method according to any of claims 4-5, wherein the likelihood ratio Λ(y) is calculated as:
$$Λ ( y ) = \frac{{Σ}_{\tilde{s} ∈ 𝒮} exp ( - \frac{{‖ y - {h}_{2} \tilde{s} ‖}^{2}}{{σ}_{{w}_{2}}^{2}} )}{{Σ}_{\tilde{s} ∈ 𝒮} exp ( - \frac{{‖ y - {h}_{1} \tilde{s} ‖}^{2}}{{σ}_{{w}_{1}}^{2}} )} .$$
where
h₁ denotes a first channel vector of coordinates (h₁₁,h₂₁), h₁₁ being the co-channel signal across the first polarization of the transmitting antenna and h₂₁ being the cross-channel signal across the first polarization of the transmitting antenna;
h₂ denotes a second channel vector of coordinates (h₁₂, h₂₂), h₁₂ being the co-channel signal across the second polarization of the transmitting antenna and h₂₂ is the cross-channel signal across the second polarization of the transmitting antenna;
σ₁ is noise variance of the noise contribution of the first polarization w₁, σ_{w2} is noise variance of the noise contribution of the second polarization w₂;
and [symbol] is a constellation of symbols s.

7. A system for providing diversity in polarization of antennas, comprising:
a transmitter for transmitting a symbol s which contains b+1 bits of information,
a receiver for receiving a signal y which obtains the b+1 bits of information from the received signal y,
wherein the transmitter comprises a single one transmitting antenna which is double polarized for transmitting the symbol s, the symbol s containing the b bits plus an additional bit c and being transmitted using a first polarization or a second polarization of the transmitting antenna depending on the additional bit c;
the receiver comprises a single receiving antenna which is double polarized for receiving the signal y and further comprises an estimator block for estimating the additional bit c to determine whether the first polarization or the second polarization is used to obtain the b+1 bits of information.

8. The system according to claim 7, wherein the single receiving antenna is configured for receiving a signal of the first polarization y₁ and a signal of the second polarization y₂, being
$$( \begin{matrix}{y}_{1} \\ {y}_{2}\end{matrix} ) = ( \begin{matrix}{h}_{11} & {h}_{12} \\ {h}_{21} & {h}_{22}\end{matrix} ) ( \begin{matrix}1 - c \\ c\end{matrix} ) s + ( \begin{matrix}{w}_{1} \\ {w}_{2}\end{matrix} )$$
where
h₁₁ is a co-channel signal across the first polarization of the transmitting antenna,
h₂₂ is a co-channel signal across the second polarization of the transmitting antenna,
h₂₁ is a cross-channel signal across the first polarization of the transmitting antenna,
h₁₂ is a cross-channel signal across the second polarization of the transmitting antenna,
w₁ is a noise contribution of the first polarization and w₂ is a noise contribution of the second polarization,
and the single one receiving antenna receives the signal y composed of the signal of the first polarization y₁ and the signal of the second polarization y₂.

9. The system according to claim 8, wherein the receiver further comprises a decoder for decoding the b+1 bits of information, obtaining the b bits from a signal r_{ĉ+1} selected from the signal of the first polarization y₁ and the signal of the second polarization y₂ which is determined by the additional bit c which is an estimated bit ĉ obtained by the estimator block as follows:
ĉ=arg maxᵢ(|rᵢ|²)−1.
where |=1, 2;
r₁ is a first matched signal from a matched filter of the receiver,
r₂ is a second matched signal from the matched filter of the receiver,
and if the first matched signal r₁ is only noise, the selected signal r_{ĉ+1} is the second matched signal r₂;
and if the second matched signal r₂ is only noise, the selected signal r_{ĉ+1} is the first matched signal r₁.

10. The system according to claim 8, wherein the receiver further comprises a decoder for decoding the b+1 bits of information, obtaining the b bits from a signal y_{ĉ+1} selected from the signal of the first polarization y₁ and the signal of the second polarization y₂ which is determined by the additional bit c which is an estimated bit ĉ obtained by the estimator block as follows:
$$\hat{c} = \frac{1 + sign ( log ( Λ ( y ) ) )}{2} .$$
where Λ(y) is a likelihood ratio of transmitting with any of the first polarization and the second polarization of the transmitting antenna,
and the selected signal y_{ĉ+1} is the signal of the second polarization y₂, if the likelihood ratio Λ(y) is Λ(h)>1; and otherwise, the selected signal y_{ĉ+1} is the signal of the first polarization y₁

11. The system according to claim 8, wherein the receiver further comprises a decoder for decoding the b+1 bits of information, obtaining the b bits from a combined received signal y_{ĉ+1} using the signal of the first polarization y₁ and the signal of the second polarization y₂ which is determined by the additional bit c which is an estimated bit ĉ obtained by the estimator block as follows:
$$\hat{c} = \frac{1 + log ( Λ ( y ) )}{2} .$$
where Λ(y) is a likelihood ratio of transmitting with any of the first polarization and the second polarization of the transmitting antenna,
and the combined received signal y_{ĉ+1} is calculated as:
$${y}_{\hat{c} + 1} r = ( 1 - {P}_{2} ) {y}_{1} + {P}_{2} {y}_{2} = \frac{{y}_{1} + {y}_{2} Λ ( y )}{1 + Λ ( y )}$$

12. The system according to any of claims 10-11, wherein the receiver calculates the likelihood ratio Λ(y) as:
$$Λ ( y ) = \frac{{Σ}_{\tilde{s} ∈ 𝒮} exp ( - \frac{{‖ y - {h}_{2} \tilde{s} ‖}^{2}}{{σ}_{{w}_{2}}^{2}} )}{{Σ}_{\tilde{s} ∈ 𝒮} exp ( - \frac{{‖ y - {h}_{1} \tilde{s} ‖}^{2}}{{σ}_{{w}_{1}}^{2}} )} .$$
where
h₁ denotes a first channel vector of coordinates (h₁₁,h₂₁), h₁₁ being the co-channel signal across the first polarization of the transmitting antenna and h₂₁ being the cross-channel signal across the first polarization of the transmitting antenna;
h₂ denotes a second channel vector of coordinates (h₁₂, h₂₂), h₁₂ being the co-channel signal across the second polarization of the transmitting antenna and h₂₂ is the cross-channel signal across the second polarization of the transmitting antenna;
σ_{w1} is noise variance of the noise contribution of the first polarization w₁, σ_{w2} is noise variance of the noise contribution of the second polarization w₂;
and [symbol] is a constellation of symbols s.

13. A receiver for providing diversity in polarization of antennas, comprising:
a single receiving antenna, which is double polarized for receiving a signal y to obtain b+1 bits of information from a symbol s transmitted by a transmitter,
an estimator block for estimating an additional bit c to determine whether a first polarization or a second polarization is used to obtain the b+1 bits of information.

14. The receiver according to claim 13, wherein the single receiving antenna (210) is configured for receiving a signal of the first polarization y₁ and a signal of the second polarization y₂, being
$$( \begin{matrix}{y}_{1} \\ {y}_{2}\end{matrix} ) = ( \begin{matrix}{h}_{11} & {h}_{12} \\ {h}_{21} & {h}_{22}\end{matrix} ) ( \begin{matrix}1 - c \\ c\end{matrix} ) s + ( \begin{matrix}{w}_{1} \\ {w}_{2}\end{matrix} )$$
where
h₁₁ is a co-channel signal across the first polarization of the transmitting antenna,
h₂₂ is a co-channel signal across the second polarization of the transmitting antenna,
h₂₁ is a cross-channel signal across the first polarization of the transmitting antenna,
h₁₂ is a cross-channel signal across the second polarization of the transmitting antenna,
w₁ is a noise contribution of the first polarization and w₂ is a noise contribution of the second polarization,
and the single receiving antenna receives the signal y composed of the signal of the first polarization y₁ and the signal of the second polarization y₂.

15. The receiver according to claim 14, further comprising a decoder for decoding the b+1 bits of information, obtaining the b bits from a signal r_{ĉ+1} selected from the signal of the first polarization y₁ and the signal of the second polarization y₂ which is determined by the additional bit c which is an estimated bit ĉ obtained by the estimator block as follows:
ĉ=arg maxᵢ(|rᵢ|²)−1.
where i=1, 2;
r₁ is a first matched signal from a matched filter of the receiver,
r₂ is a second matched signal from the matched filter of the receiver,
and if the first matched signal r₁ is only noise, the selected signal r_{ĉ+1} is the second matched signal r₂;
and if the second matched signal r₂ is only noise, the selected signal r_{ĉ+1} is the first matched signal r₁.

16. The receiver according to claim 14, wherein the receiver further comprises a decoder for decoding the b+1 bits of information, obtaining the b bits from a signal y_{ĉ+1} selected from the signal of the first polarization y₁ and the signal of the second polarization y₂ which is determined by the additional bit c which is an estimated bit ĉ obtained by the estimator block as follows:
$$\hat{c} = \frac{1 + sign ( log ( Λ ( y ) ) )}{2} .$$
where Λ(y) is a likelihood ratio of transmitting with any of the first polarization and the second polarization of the transmitting antenna,
and the selected signal y_{ĉ+1} is the signal of the second polarization y₂, if the likelihood ratio Λ(y) is Λ(y)>1; and otherwise, the selected signal y_{ĉ+1} is the signal of the first polarization y₁.

17. The receiver according to claim 14, wherein the receiver further comprises a decoder for decoding the b+1 bits of information, obtaining the b bits from a combined received signal y_{ĉ+1} using the signal of the first polarization y₁ and the signal of the second polarization y₂ which is determined by the additional bit c which is an estimated bit ĉ obtained by the estimator block as follows:
$$\hat{c} = \frac{1 + log ( Λ ( y ) )}{2} .$$
where Λ(y) is a likelihood ratio of transmitting with any of the first polarization and the second polarization of the transmitting antenna,
and the combined received signal y_{ĉ+1} is calculated as:
$${y}_{\hat{c} + 1} r = ( 1 - {P}_{2} ) {y}_{1} + {P}_{2} {y}_{2} = \frac{{y}_{1} + {y}_{2} Λ ( y )}{1 + Λ ( y )}$$

18. The receiver according to any of claims 16-17, wherein the estimator block calculates the likelihood ratio Λ(y) as:
$$Λ ( y ) = \frac{{Σ}_{\tilde{s} ∈ 𝒮} exp ( - \frac{{‖ y - {h}_{2} \tilde{s} ‖}^{2}}{{σ}_{{w}_{2}}^{2}} )}{{Σ}_{\tilde{s} ∈ 𝒮} exp ( - \frac{{‖ y - {h}_{1} \tilde{s} ‖}^{2}}{{σ}_{{w}_{1}}^{2}} )} .$$
where
h₁ denotes a first channel vector of coordinates (h₁₁,h₂₁), h₁₁ being the co-channel signal across the first polarization of the transmitting antenna and h₂₁ being the cross-channel signal across the first polarization of the transmitting antenna;
h₂ denotes a second channel vector of coordinates (h₁₂, h₂₂), h₁₂ being the co-channel signal across the second polarization of the transmitting antenna and h₂₂ is the cross-channel signal across the second polarization of the transmitting antenna;
σ_{w1} is noise variance of the noise contribution of the first polarization w₁, σ_{w2} is noise variance of the noise contribution of the second polarization w₂;
and [symbol] is a constellation of symbols s.

19. (canceled)

20. Computer program comprising computer program code adapted to perform the steps of the method according to claim 1, when said program is run on a computer, a digital signal processor, a field-programmable gate array, an application-specific integrated circuit, a micro-processor, a micro-controller, or any other form of programmable hardware.
